(19) United States
(12) Patent Application Publication
(10) Pub. No.: US 2010/0127965 A1
(43) Pub. Date: May 27, 2010

(54) MERCHANDISE DISPLAY DEVICE WITH COLOR-CHANGING SURFACE AND METHOD OF FABRICATING THE SAME

(75) Inventor: Jaesang Park, Seoul (KR)

Correspondence Address: Jaesang Park;Feo Display Co., LTD., Korea Polytechnic College Business, Incubation Center Rm. 212, Sansung-dong 4, Soojung-gu, Sungnam-si, Kyunggi-do, 461-711, KR

(73) Assignee: FEO Display, Sungnam-si ,Kyunggi-do (KR)

(21) Appl. No.: 12/452,461

(22) PCT Filed: Jul. 3, 2008
(86) PCT No.: PCT/KR2008/003924

§ 371 Date: Dec. 31, 2009

(30) Foreign Application Priority Data
Jul. 4, 2007 (KR) 10-2007-0066823

(51) Int. Cl. G09G 3/38

(52) U.S. Cl. 345/105

(57) ABSTRACT

A merchandise display device comprising: an electro-optic display member having an effective display area capable of displaying colors or images; a first means for displaying merchandise on or near said effective display area; a second means for providing physical support to said electro-optic display member; and a controller device for driving said electro-optic display member. The merchandise display device is capable of showing dynamic colors, images, or both on its surface, and an article of merchandise may be displayed on or near said surface, with said dynamic colors, images, or both being the display background.

### TECHNICAL FIELD

The present invention relates to merchandise display devices. In particular the invention relates to a merchandise display device that allows merchandise to be displayed on multiple background colors or background images that appear in sequence, by means of having a surface area that includes an electro-optic display device.

### DISCLOSURE OF INVENTION

### Technical Problem

In selling an article of merchandise, attracting shoppers' attention is an important step, and sellers spend substantial expenses to attract shoppers' attention. However, even after a shopper's attention is attracted, there are additional steps until the relevant merchandise is sold, and existing merchandise display devices have the following problems.

In general, an article of merchandise purchased is used on certain background colors, and a potential customer may wish to see the article on such colors, or may prefer an article displayed on a certain background color to an article displayed on another background color, even if the article is identical. However, as conventional merchandise display devices are incapable of changing the color of the devices themselves, in order for a potential customer to see an article displayed on a background color other than the color on which the article is already displayed, the customer must enter the store or be already in the store, and then have the article placed upon an object that has a different color, either on his or her own or with the help of a store employee. Even if the potential customer has a potential intention to purchase the article, in many cases the customer is reluctant to initiate such a process, and if the process is not initiated, the customer generally does not purchase the article. Other problems associated with such a process exist, such as: time spent by the store employees; a resulting need to hire more store employees; time spent by the potential customer; and a potential decrease in value or loss of merchandise during the process of moving the merchandise. Additionally, it is not possible with a conventional merchandise display device to display an article of merchandise on more than one background color to suit various potential customers' tastes.

In order to solve these problems, a plurality of identical articles of merchandise may be displayed on differently-colored merchandise display devices, which however causes an inefficient use of merchandise stock and display space.

These problems are particularly troublesome with respect to merchandise for which various background colors that the merchandise will be used upon are generally pre-determined by such factors as the user s skin tone and the colors of the clothes that the users already own, for example wearable items such as necklaces, rings, bracelets, watches, and other fashion accessories, and clothing items. In particular, sellers of such merchandise tend not to display more than one identical article in order to stress the uniqueness of the merchandise.

As a background color for displaying fashion accessories or clothing items, bright colors such as white or satin white and dark colors such as black are generally preferred to medium-tone colors. There may be a number of reasons for the preference, but one of the reasons is that human skin color may generally be perceived as dark or bright. However, a seller in general does not exclusively target either dark-skinned persons or bright-skinned persons. Nevertheless, the seller is forced to choose either a dark or a bright color as the display background color for an article of merchandise, risking the possibility of the article appearing less appealing to a potential customer with substantially the opposite skin color. This may be of a particular interest to sellers of fashion accessories or clothing items operating in a multi-racial market.

Additionally, conventional merchandise display devices, which are statically-colored, are less than satisfactory in drawing potential customers' attention. It is an established fact that movements in color, shape, location, or the like have an effect of drawing shoppers' attention at least some of which results ultimately in sales.

### Technical Solution

An object of the present invention is in solving the above-described problems, in particular in providing at least one merchandise display device comprising a layer of electro-optic display medium near the surface, enabling the color of the viewing surface to change, as well as in providing the fabrication method thereof.

In an embodiment of the present invention, a merchandise display device comprises: an electro-optic display member having at least one effective display area; a placement member providing a means for displaying at least one article of merchandise on or near the effective display area; a support member providing physical support to the display member; and a controller device which drives the display member.

In another embodiment, a method of fabricating a merchandise display device comprises: providing a frontplane including a first electrode and an electro-optic medium layer; providing a backplane including a second electrode; providing a display member having an effective display area capable of showing colors and/or images, by means of joining the frontplane and the backplane; providing a support member which physically supports the display member; providing a placement member providing a means for displaying merchandise on or near the effective display area; and providing a controller device generating an electric input to the display member.

### ADVANTAGEOUS EFFECTS

The present invention provides merchandise display devices that allow for displaying an article of merchandise on a plurality of background colors that automatically change in a certain sequence, thereby enabling potential buyers to easily see the article on different background colors and to reduce inefficient use of time. For sellers, an article of merchandise may be displayed to suit the tastes of a larger number of potential buyers; merchandise inventory and display space may be used efficiently; costs related to selling merchandise may be reduced; loss of or damage to merchandise may be reduced; and potential shoppers' attention may be attracted. Additionally, for a seller of wearable merchandise, the target marketing pool can be expanded to include those who have a dark skin color or dark-colored clothing and those who have a light skin color or light-colored clothing, by the display of one article of merchandise on dark and light colors. Above-mentioned advantages individually or collectively bring an enhanced shopping experience to shoppers, and increased sale and reduced costs to sellers.

The present invention also provides a method of fabricating a merchandise display device, wherein a merchandise display device having a surface area capable of changing the color and/or the image may be fabricated at a low cost, in a simple process, and in various shapes and sizes, by the use of a frontplane and a backplane that are produced separately.

In at least one embodiment, the present invention also provides a configuration of a plurality of display panels whereby a simply-structured controller device may drive a plurality of display panels disposed substantially on the same plane.

### BRIEF DESCRIPTION OF THE DRAWINGS

FIG. 1 is an isometric view of an embodiment of the present invention referred to in this application as Embodiment No. 1.

FIG. 2 is an exploded view of an embodiment of the present invention referred to in this application as Embodiment No. 1.

FIG. 3 is a side view of an embodiment of the present invention referred to in this application as Embodiment No. 1.

FIG. 4 is a schematic cross sectional view taken along the plane indicated by I-I in FIG. 2.

FIG. 5 is a schematic cross sectional view taken along the plane indicated by II-II in FIG. 2.

FIG. 6 is an isometric view of an embodiment of the present invention referred to in this application as Embodiment No. 2.

FIG. 7 is a schematic cross sectional view taken along the plane indicated by III-III in FIG. 6

FIG. 8 is a schematic front view of the support member of an embodiment of the present invention referred to in this application as Embodiment No. 3.

FIG. 9 is an isometric view of an embodiment of the present invention referred to in this application as Embodiment No. 4.

FIG. 10 is a schematic cross sectional view taken along the plane indicated by IV-IV′ in FIG. 9.

FIG. 11 is a schematic cross sectional view taken along the plane indicated by V-V′ in FIG. 9.

FIG. 12 is a schematic cross sectional view of the placement member and the display member of an embodiment of the present invention referred to in this application as Embodiment No. 5.

FIG. 13 is a schematic cross sectional view of the placement member and the display member of an embodiment of the present invention referred to in this application as Embodiment No. 6.

### MODE FOR THE INVENTION

Certain important terms used in this application are defined below. Terms and words employed in this application shall not be restricted to their dictionary definitions. In accordance with the principle that the inventor may define terms in order to appropriately explain the invention, the terms and words employed in this application shall be understood in accordance with the spirit of the present invention.

In general, the display member of an electro-optic device includes a layer of electro-optic medium interposed between at least two electrodes. At least one of the two electrodes is generally made of a transparent electric conductor such as indium tin oxide (ITO) or indium zinc oxide (IZO), and through this transparent electrode is the change of the optical state of the electro-optic medium observed. The transparent electrode is formed on a transparent substrate such as glass or polyethylene terephthalate (PET). A structure comprising a transparent electrode, a transparent substrate, and a layer of electro-optic medium is referred to as an electro-optic display frontplane or simply a frontplane in this application. The transparent electrode included in a frontplane is referred to as a top electrode in this application. A top electrode may be a first or a second electrode below in this application. A frontplane may include elements other those described above, depending on the type of electro-optic medium or the operating method. The electrode that is located on the opposite side of the electro-optic medium layer from the top electrode is referred to as a bottom electrode in this application, and is made of, depending on the type of electro-optic medium or the operating method, a transparent or an opaque electric conductor. A bottom electrode may be a first or a second electrode below in this application. A bottom electrode may be formed on a transparent or an opaque substrate; a structure comprising a bottom electrode and the transparent or opaque substrate is referred to as an electro-optic display backplane or simply a backplane in this application. A backplane may include elements other than those described above depending on the type of electro-optic medium or the operating method. A structure comprising a frontplane, a backplane, and in certain cases a protective layer or protective layers described below is referred to as an electro-optic display panel or simply a display panel in this application. A certain area or side of the electro-optic medium layer may not be in electrical communication with one or both of the two electrodes and therefore the optical state of the electro-optic medium layer may not change; and a certain area or side of the electro-optic medium layer may be covered by an opaque material and therefore may not be visible. Such an area or side is referred to as a non-effective display area or non-effective display surface. In contrast, the area or side where the change of the optical state can be observed is referred to as an effective display area or effective display surface. In manufacturing an electro-optic device, in order to enforce adhesion between layers, to physically contain electro-optic media, to protect electro-optic media from environmental factors, and/or to achieve other purposes, a layer or layers of protective material enclosing other elements may be provided by the use of such methods as lamination. In general, a protective layer encloses other elements in abutment against another protective layer or a substrate around the edges of a display panel. As such, the area that is physically united with a display panel but where an electro-optic medium layer is not present is referred to as a margin area in this application. Depending on the method of operation, either the top or the bottom electrode may form a common electrode and may be used as a ground electrode, while the other electrode is used as a pixel electrode which supplies electric signals to each of optically independent areas of a display panel. In such a case the ground electrode may not be supplied with an electric signal, but for the purpose of convenience, a conductive material that electrically connects a controller device and a ground electrode or a pixel electrode is referred to as a voltage rail or a voltage supply means.

An object of the present invention is in solving the above-described problems, in particular in providing merchandise display devices comprising a layer of electro-optic display medium near the surface, enabling the color of the viewing surface may change, as well as in providing the fabrication method thereof.

Numerous types of electro-optic display devices using varying types electro-optic medium and driving method have been developed or researched, including: twisted nematic liquid crystal display (TN LCD); super twisted nematic LCD (STN LCD); cholesteric LCD (Ch-LCD); electrophoretic display; bichromal ball display; electrochromic display; electrowetting display; zenithal bistable nematic device (ZBD); electro-liquid powder display; micro electro mechanical system (MEMS); and other bistable LCD. “Bistable” or “multistable” indicates a property of an electro-optic display where the relevant electro-optic medium has two or more optical states, and if one of the optical state is achieved by the application of a voltage in a certain pulse, that optical state is maintained at least several times the shortest duration of voltage application needed to change the optical state, without a further supply of voltage. “Bistable” as used in this application is inclusive of “multistable.”

The present invention provides merchandise display devices having at least one of the above-mentioned and other electro-optic display devices near its surface, and the fabrication method thereof.

Another object of the present invention is in providing a relatively simple and low-cost method of manufacturing such merchandise display devices, in particular by the use of a frontplane and a backplane that are separately produced.

In general, a certain area of an electro-optic medium layer interposed between two electrodes changes its optical characteristics, such as opacity, reflection of light in certain wavelength, illumination, and so on, by the voltage applied to the electrodes. A display panel as a whole may display certain images or texts as a result of voltages applied to certain areas of the two electrodes. In order to display images or texts, it is necessary to manipulate the optical characteristics of an area of electro-optic medium layer without affecting the optical characteristics of neighboring areas; and to achieve this, the electrodes need to be formed so that electric crosstalk between neighboring areas are substantially eliminated, and also a corresponding voltage supply means is necessary. Electro-optic display devices are generally manufactured for purposes of displaying information in the form of images or texts, and in order to display images or texts a relatively large number of optically independent areas are needed. This requires a complex electrode structure and correspondingly complex voltage supply means, although the degree of complexity may vary depending on the purpose of the electro-optic display device. Forming such complex electrodes and voltage supply means accounts for a substantial portion of efforts and costs in the manufacture of electro-optic display panels.

Direct driving, passive matrix (PM) driving, and active matrix (AM) driving are some of electro-optic display driving methods with varying structures of electrodes and voltage supply means. Generally, a direct driving method may be used when relatively simple images or texts are needed, and matrix methods are used for more complex images and texts. Under a direct driving method, an electrode is divided into electrically separate areas, and each such area is supplied with a voltage through a separate voltage rail.

In at least one embodiment of the present invention, an electro-optic display member need not display any image or text but instead is driven in such a way that all surface areas are in substantially the same optical state; in other words the display member contains a single optically independent area. Thus, electric crosstalk is not an issue and therefore there arises no need for a complex electrode, a complex voltage supply means, or the accompanying manufacturing processes. Electrically conductive metal foils or plates that are readily available in the market or polymer films coated with a conductive material such as a conductive metal or carbon may be used to provide a pixel electrode. Additionally, electrodes may be driven with a direct driving method which is simpler than matrix methods. Even for an electro-optic display device driven by a direct driving method, a relatively complex structure of electrode is required in order to display information, but in at least one embodiment of the present invention a simply-structured electrode may be used.

Various methods exist for placing an electro-optic medium layer between two electrodes. For example, in the case of active matrix LCD displays, which are used as computer monitors and the like, conventionally two glass plates with an electrode layer formed on one side of each are placed so that the electrodes face each other and are spaced, the edges of the two glass plates are sealed, and liquid crystal is injected in the space between the two glass plates. A manufacturing process involving such stages is generally streamlined and requires high-cost equipment, making it difficult to economically produce electro-optic display panels in various shapes and sizes.

Another method of placing an electro-optic medium layer between two electrodes is to manufacture a frontplane and a backplane separately and then combine them. As described above, in at least one embodiment of the present invention, a simply-structured pixel electrode may be used; thus a merchandise display device can be economically produced by joining a separately-produced frontplane including a common electrode with a backplane including a simply-structured pixel electrode. Electro-optic display frontplanes that may be used with this method include certain electrophoretic display frontplanes. For example, E Ink Corporation (Cambridge, Mass., USA) and Sipix Imaging, Inc. (Fremont, Calif., USA) produce electrophoretic frontplanes using a roll-to-roll method which enables low-cost production. Besides electrophoretic display frontplanes, electro-optic display frontplanes and backplanes that allow for separate manufacture of and later combination of a frontplane and a backplane can be used for at least one embodiment of the present invention.

Yet another object of the present invention is to provide an article of and a fabrication method for a merchandise display device having a plurality of display panels or display frontplanes planarly connected in an efficient and visually pleasing manner. In general it is difficult to manufacture an electro-optic display panel or a frontplane larger than a certain size, due to the cost of manufacturing and/or technical limitations including limitations in manufacturing equipment. As described above, as display panels tend to have margin areas, if display panels are connected in a planar manner in order to produce a display unit that is larger than the maximum size of a single display panel, the margin areas give a rise to a gap of roughly the same width as the margin areas between display panels. One embodiment of the present invention is a merchandise display device comprising a support member shaped similarly to a picture frame, display panels connected in a planar manner by the support member, and voltage rails provided in or by the support member; whereby the margin areas between display panels are concealed by the support member, voltage rails are provided in an efficient and visually pleasing manner, and a single simply-structured controller device may drive the display panels. Another embodiment of the present invention is a merchandise display device comprising a single backplane and a plurality of frontplanes smaller in area than the backplane.

Still another object of the present invention is to provide a merchandise display device having a curved planar or three-dimensional surface area, wherein the surface area includes a single display panel. In at least one embodiment of the present invention, a display panel comprising a flexible substrate is included in the surface area of a merchandise display device. As roll-to-roll production of frontplanes requires a flexible substrate to be used, frontplanes produced in a roll-to-roll process, including the above-described electrophoretic display frontplanes, can be used in this case. The use of a flexible substrate is a subject of continuous research with respect to other types of electro-optic displays as well, and in certain cases test production has been completed. For example, Fujitsu Laboratories, Ltd. (Kawasaki, Kanagawa, Japan) produced Ch-LCD on a flexible substrate. In another embodiment of the present invention, a long and thin strip-shaped flexible display panel is affixed longitudinally to a coil-shaped metal rod, and a controller device is put in electrical connection with the display member's two electrodes.

Still another object of the present invention is to provide a merchandise display device having a three-dimensional surface area comprising a plurality of electro-optic display panels. As described above, conventional display panels are generally formed on a rigid substrate, for the need to form a complex electrode and corresponding voltage supply means, or to maintain a certain uniform distance between the two electrodes between which an electro-optic medium layer is interposed, and so on. However, in many cases a merchandise display device requires a three-dimensional shape, and with rigid substrates such as glass it is difficult to produce such a shape. Also, as described above, a display panel may be formed on a flexible substrate but not on an elastic substrate, for it is difficult to control the optical state of electro-optic media whose arrangement is altered by the contraction or expansion of the substrate. Additionally, it is difficult to form an electrode layer on an elastic substrate. Thus it is difficult to create a three-dimensional form with a single conventional display panel. It is possible to create a three-dimensional form with a plurality of conventional display panels. In this case, however, each of the display panels needs to be electrically connected to a controller device and thus a large number of voltage rails may be necessary, a complexly-structured controller device that is capable of controlling a large number of voltage rails may be necessary, and because one controller device may be incapable of controlling all display panels a plurality of controller devices may be necessary. In another embodiment of the present invention, a conductive metal rod is shaped into a three-dimensional skeleton, a plurality of display panels of a certain size are affixed to the three-dimensional skeleton, all of either top or bottom electrodes of the display panels are electrically connected to one voltage supply terminal of a controller device via the three-dimensional skeleton, and all of the other electrodes are electrically connected to another voltage supply terminal of the controller device.

At least one embodiment of the present invention may be used for purposes other than displaying merchandise, for example as an interior decoration piece or for drawing public attention.

In order to solve the above-described problems and to achieve the above-described objects, a merchandise display device provided by the present invention may comprise: a display member having an effective display area capable of showing colors and/or images; a support member of a certain or more rigidity that provides physical support to the display member; a placement member providing means for displaying merchandise on or near the effective display area; and a controller device including a power supply element, an electric circuit, and a microprocessor device, for driving the display member.

For the display member, various types of non-emissive electro-optic displays may be used, such as above-described TN LCD, STN LCD, and Ch-LCD. An emissive electro-optic display emits light in order to display a color, text, or image. Examples of emissive displays include LCD used generally for a television or a computer monitor, OLED, and EL. If the supply of power is terminated, the emission of light is also terminated, and the emissive display no longer displays the previously displayed color, image or text. Non-emissive displays display a color, text, or image by reflecting ambient light. Examples of non-emissive displays include certain elec-electrophoretic, cholesteric liquid crystal, electrowetting, and electrochromic displays. Non-emissive displays may suit the purposes of displaying merchandise better than emissive displays, for such reasons as the light emission from an emissive display overwhelming the merchandise displayed. Particularly in the case of wearable merchandise, the seller may purport to display the merchandise as if it were worn by a person, and a person's skin or cloth generally does not emit but reflect light.

Among non-emissive displays, the kinds that allow for separate production of the frontplane and the backplane, such as non-emissive displays produced by above-mentioned E Ink Corporation and Sipix Imaging, Inc., are particularly suitable for the present invention, as they allow for relatively easy manufacture of display members of the present invention in various shapes and sizes. Xerox Corporation (Stamford, Conn., USA) in the past produced through its subsidiary Gyricon, LLC (Palo Alto, Calif., USA) bichromal ball display frontplanes, but is currently only licensing the technology. Electrochromic displays, which may be produced at a relatively low cost and may express limited but relatively various colors, may be used for at least one embodiment of the present invention, although the frontplane and the backplane are not separately produced. Companies such as Ntera, Inc. (West Conshohocken, Pa., USA) produce electrochromic displays commercially. Also, Ch-LCD, which may express limited but relatively various colors, may be used for at least one embodiment of the present invention. Companies such as Kent Displays Incorporated (Kent, Ohio, USA) commercially produce Ch-LCD. Besides those mentioned above, various electro-optic displays are being developed and researched, and there may be various other electro-optic displays that are in accordance with the present invention.

Various electro-optic displays express colors by the use of a color filter layer, by the use of electro-optic media that exhibit a certain native color or native colors, or by the combination of both. All electro-optic displays capable of expressing more than one color could be used for an embodiment of the present invention; however, for carrying out the present invention at a relatively low cost, the use of electro-optic media that exhibit a certain native color or native colors may be more suitable.

If, for example, the number of colors that can be expressed by a display member is limited to two, it is possible to provide a colored transparent or translucent film to create appropriate colors. In this case, the film may have a native color, or colors may be printed on the film. Additionally, the film may or may not have a color while having a textured surface. Additionally, the film may be in direct contact with the effective display area of a display member, or may be placed a certain distance away from the effective display area. Alternatively, in lieu of a transparent or translucent film, an anti-glare surface treatment agent or the like may be used.

A display member may be fabricated in different shapes and sizes by a variety of methods. In the case of a display panel produced by the joining of a frontplane and a backplane that are separately produced, the frontplane and the backplane may be first cut in certain shapes and then joined, or the frontplane and the backplane may be joined first and then cut in a certain shape. The frontplane, or the structure created by the joining of the frontplane and the backplane, should be such that appropriate adhesion between the layers of the frontplane, i.e. transparent substrate, top electrode, and electro-optic medium layer, is maintained when cut along a random line, and various electro-optic displays posses such a characteristic. For example, Sipix Imaging Inc. provides for such appropriate adhesion by the use of a frontplane manufactured by first forming cup-shaped micro-cavities on an ITO-coated PET substrate on the side coated with ITO, and then filling the cavities with electro-optic media, and then sealing the cavities. E Ink Corporation provides for such appropriate adhesion by the use of a frontplane manufactured by, using a material with an appropriate viscosity, affixing microcapsules comprising electro-optic media onto an ITO-coated PET substrate on the side coated with ITO. Commercially available cutting plotters or laser cutting machines may be used for the cutting of the frontplane or the structure created by the joining of the frontplane and the backplane. If the frontplane and the backplane cannot be separately fabricated, i.e. when an entire display member needs to be produced in a continuous process, the display member generally needs to be produced in the desired shape and size under the continuous process.

A backplane may be transparent or opaque. If both front and back sides of a display member comprise effective display areas, it may be possible to use as the backplane a transparent polymer film coated with a transparent electric conductor material, for example Mylar (Mylar is a registered trade mark of DuPont) film coated with ITO. If the backplane is to be opaque, it may be possible to use as the backplane a polymer film coated with an opaque electric conductor, for example a Mylar film coated with aluminum that is commercially available, or a PET film coated with aluminum, carbon, or silver.

A backplane may be formed on a flexible or a rigid substrate. If a flexible substrate is to be used, the above-mentioned Mylar film coated with an electric conductor may be used as the backplane, for example; if a rigid substrate is to be used, the backplane may be provided by, for example, affixing the Mylar film coated with an electric conductor onto a rigid plate made of metal or polymer such as acrylic or polyvinyl chloride (PVC). Such metal or polymer plates are readily available in various shapes. If the rigid plate is made of an electrically conductive metal such as aluminum or copper, or coated with an electric conductor, the rigid plate itself may be used as a the backplane. A plate made of glass coated with an electric conductor also may be used as a backplane.

In at least one embodiment of the present invention, as described above, a direct driving method may be used. One advantage of a direct driving method is that the electrode structure and the voltage supply means are relatively simple and that they can be economically manufactured. One disadvantage of a direct driving method is that it is limited in displaying various colors, images, or texts. With respect to a merchandise display device, displaying various images or texts on the surface area is generally not an essential feature; if needed, however, a display member driven by a matrix method, namely AM and PM, may be employed. In manufacturing a matrix-type backplane, especially in manufacturing a thin film transistor (TFT) layer commonly used for an AM-type backplane, due to the manufacturing process that requires a high-temperature processing, a rigid glass substrate is generally used. However, flexible substrates that withstand a high temperature and low-temperature TFT manufacturing processes are being researched, and either a flexible or a rigid matrix-type backplane may be used in at least one embodiment of the present invention. Plastic Logic Limited (Cambridge, England), Polymer Vision (Eindhoven, the Netherlands), LG Philips LCD Co., Ltd. (Seoul, Korea), Hewlett-Packard Company (Palo Alto, Calif., USA), Fujitsu Laboratories Ltd., and other companies have non-commercially produced flexible matrix-type backplanes.

As described above, in at least one embodiment of the present invention, the color of a display panel changes so that the color of the entire display panel is substantially the same at a given time. In such an embodiment, especially when the bottom electrode is used as the pixel electrode, the bottom electrode may be one electrode that is electrically continuous. Also in such an embodiment, and if the frontplane and the backplane are such that they are separately manufactured and then later joined, an adhesive agent may used in joining the frontplane and the backplane; and as crosstalk is not an issue, an adhesive agent with isotropic electrical conductivity as well as an agent with anisotropic electrical conductivity may be used. 3M Company (St. Paul, Minn., USA) and Henkel Corp. (Rocky Hill, Conn., USA) etc. sell adhesive agents with isotropic conductivity as well as adhesive agents with anisotropic conductivity. In another embodiment, however, the color of a display panel may change so that the color of one area of the display panel is different from the color of another area. In such an embodiment, in particular if the bottom electrode is used as the pixel electrode, the bottom electrode needs to comprise a plurality of electrically separated areas rather than being one electrically continuous electrode. Also in such an embodiment, in particular if the frontplane and the backplane are such that they are separately manufactured and then later joined, an adhesive agent having anisotropic electrical conductivity in the direction substantially perpendicular to the bottom electrode needs to be used. An adhesive agent having such anisotropic conductivity may be provided applied on the frontplane on the opposite side of the electro-optic medium layer from the top electrode by the producer of the frontplane, or may be separately procured and applied.

As described above, an electro-optic display panel may comprise a protective layer or protective layers enclosing other elements. Such a protective layer or protective layers may be used for at least one embodiment of the present invention as well. Films made of a substantially transparent polymer such as PET may be used as a protective layer.

If it is necessary to protect the display member from environmental factors such as ultraviolet ray or moisture, and if the protective layer does not provide sufficient protection, additional protective means may be used. For an effective display area or surface, a substantially transparent film made of such a material as polyvinylidene chloride (PVDC) or polychlorotrifluoroethylene (PCTFE) may be used as a moisture barrier. These materials generally also have ultraviolet ray barrier properties; however, if an additional protective means against ultraviolet ray is needed, a commercially available ultraviolet ray barrier solution or film may be appropriately used. Also, such a moisture barrier film or an ultraviolet ray barrier film itself may be used as the protective layer. For protection of a non-effective display area or surface from moisture, the same moisture barrier film or a layer of such opaque materials as aluminum may be used at an appropriate location. A non-effective display area is in general covered with an opaque material, and thus protection from ultraviolet ray is generally not an important issue.

A support member of a certain or more rigidity that provides physical support to the display member may be formed in various ways. In one embodiment, a polymer plate is affixed onto the rear side of a display panel in the form of a layer. In another embodiment, a plurality of structures, formed by affixing a polymer plate onto the rear side of a display panel, are in turn affixed to a coil-shaped additional support member. In yet another embodiment, a flexible rectangular electro-optic display panel is formed into a cylindrical shape, and a support member is placed longitudinally between the two adjacent edges of the display panel. In yet another embodiment, an in-mold design (IMD) method is used to provide a permanent fixation of a display member to an injection-mold structure. Other support members of various shapes and materials, for example metal wire, coil, bar, curved plate, picture frame, and so on, as well as combinations of them, may be used in planar or three-dimensional forms.

Means for affixing a display member to a support member may be appropriately provided depending on the properties of the display member and the support member. For example, a hot-melt adhesive, a pressure-sensitive adhesive, a clamp, a magnet, a metal wire, a fiber wire, an injection-molded structure, a bolt and nut, various picture-frame-like structures, etc. may be used.

In at least one embodiment of the present invention, a placement member, which provides a means for displaying merchandise on or near the surface of an effective display area of a display member, includes the display member, the support member, or the combination of the two. For example, a planar support member in the shape of human chest is affixed to a display member of a substantially identical shape, so that a necklace may be displayed on the effective display area. In another embodiment, the display member is formed into a cylindrical shape so that a wristwatch or bracelet may be displayed, i.e. so that the placement member providing a means for displaying merchandise is provided by the display member itself. In yet another embodiment, a placement member providing a means for displaying a clothing item is provided by affixing display members to a three-dimensional, human-body-like support member. In yet another embodiment, a placement member providing a means for displaying a wristwatch is provided by a cone-shaped display panel. In such embodiments, in other words in embodiments wherein a means for displaying merchandise on or near an effective display area comprises a display member, a support member, or the combination of the two, if in particular the display member includes a substrate of an appropriate rigidity, the display member alone may provide a placement member providing a means for displaying merchandise on or near the effective display area.

In another embodiment, a second support member provides a placement member providing a means for displaying merchandise on or near an effective display area. The second support member may be provided in the form of a hook, a ledge, a pin, or the like; and may be affixed on an effective display area or on the opposite side so that an article of merchandise may be displayed on or near the effective display area. For example, in the case of a necklace, the second support member may be affixed on the opposite side of an effective display area so the necklace may be displayed on or near the effective display area. As for affixing the second support member onto a merchandise display device, such materials as a polymer tape having pressure-sensitive adhesives on both sides may be used. In another embodiment, a magnetic field provides a means for affixing the second support member to a merchandise display device.

A placement member provided by a second support member may particularly be appropriate for fashion accessories such as necklaces, rings, pendants, earrings, bracelets, anklets, and wristwatches; an article of clothing; and relatively small and light electronic consumer goods.

A controller device that drives a display member may comprise a power supply member, an electric circuit, and a microprocessor device, and may have various configurations depending on the driving method for the display member. The power supply member supplies appropriate electric currents to the electric circuit and the microprocessor device; the microprocessor device includes a program controlling what voltages are applied in what sequence and intervals to an electrode or electrodes included in the display member; the electric circuit applies appropriate voltages to an electrode or electrodes included in the display member in accordance with the program included in the microprocessor device. The controller device applies voltages in appropriate waveform to the electrode or electrodes in accordance with intended changes to the optical state of the display member. Direct drive and matrix-type controller devices capable of generating voltages in predetermined waveforms are readily available in the market.

In embodiments described in detail below in reference to FIGS., particularly often used is a display member driven by a direct driving method and wherein an electro-opt is medium layer is interposed between two electrodes. A controller device capable of driving an STN LCD is generally capable of appropriately driving such a display member. STN LCD controllers are readily available in the market.

A single controller device may drive a single display panel or a plurality of display panels. If one controller device controls a plurality of display panels, the controller device may be programmed so that all display panels exhibit or do not exhibit substantially the same optical state at a given time; or the controller device may be programmed so that all the display panels as a unit exhibit certain optical characteristics in a certain sequence and intervals. For example, a controller device may be programmed so that each of four display panels turns to black one by one, or so that the first and third of the four display panels always exhibit the same color.

Display members manufactured with substantially the same materials in substantially the same process may not have identical optical characteristics, due to small differences in material and process. A controller device may be programmed to supply voltages in appropriate waveforms to compensate for such differences in optical characteristics.

The above-described elements of a controller device may be included in one physical unit, or may be provided separately. For example, a controller device may be configured to include batteries or to be connected to an external alternating current power source may be connected to the controller device.

A display member and a controller device may be put in electrical communication with each other by means of a connecting member. Various electrically conductive materials such as aluminum, copper, carbon, ITO, and silver may used in an appropriate form, for example being coated on a transparent or opaque polymer film, to provide a connecting member. Also, a connecting member may comprise an extension of an electrode included in the display member. A connecting member may be concealed with a strip of fabric or polymer, or the like. Also, a connecting member may further comprise an insulated copper wire, a bar-shaped material coated with an electric conductor, a bar made of an electric conductor, or the like. A connecting member may be physically integrated with the support member. A connecting member and the controller device or an electrode of the display member may be permanently connected by the use of a hot-melt adhesive or the like, or may be connected using a clip, a plug, or the like so that disconnection and reconnection can be easily performed.

While efforts have been made above to describe the present invention, there may be various embodiments of the present invention. The present invention is further described below with respect to certain embodiments in reference to FIGS. accompanying this application.

### Embodiment No. 1

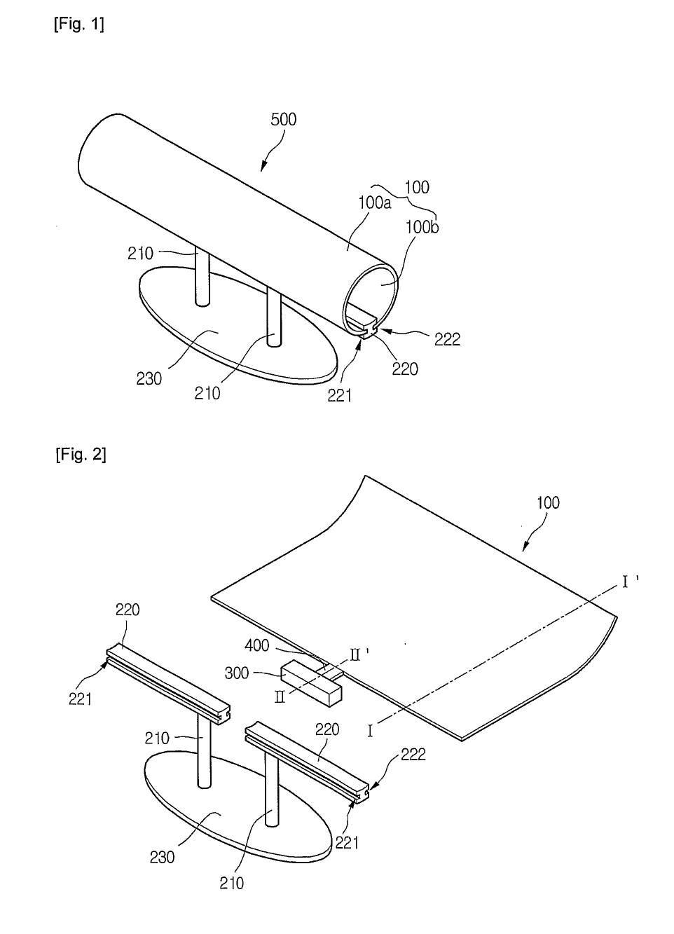

FIG. 1 is an isometric view of an embodiment of the present invention referred to in this application as Embodiment No. 1.

FIG. 2 is an exploded view of an embodiment of the present invention referred to in this application as Embodiment No. 1.

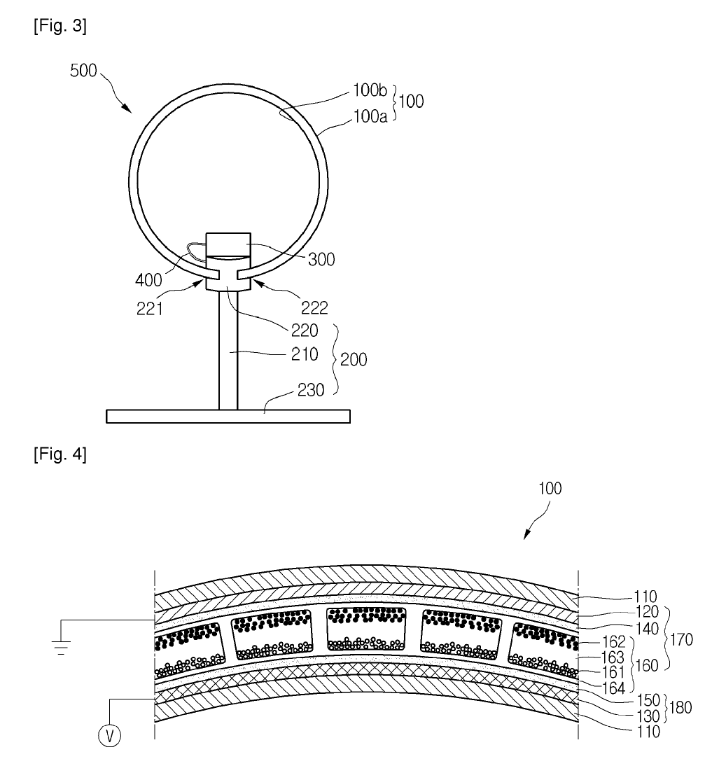

FIG. 3 is a side view of an embodiment of the present invention referred to in this application as Embodiment No. 1.

FIG. 4 is a schematic cross sectional view taken along the plane indicated by I-I in FIG. 2.

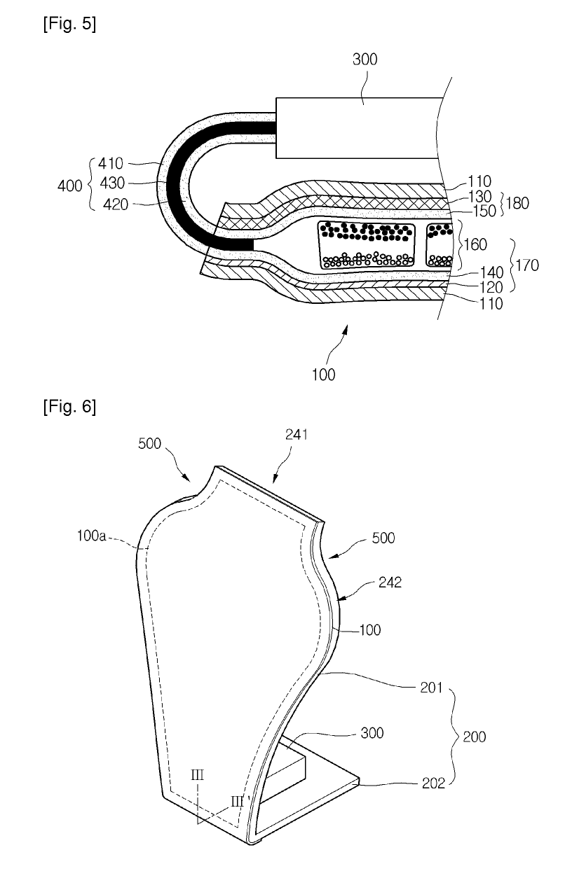

FIG. 5 is a schematic cross sectional view taken along the plane indicated by II-II in FIG. 2.

In reference to FIGS. 1 and 3, a merchandise display device comprises display member (100), support member (200), controller device (300), connecting member (400), and placement member (500).

Display member (100) comprises effective display area (100a) and non-effective display area (100b). Display member (100) is of a cylindrical shape, with effective display area (100a) facing outward and non-effective display area (100b) facing inward.

In reference to FIG. 4, display member (100) comprises protective layers (110), first substrate (120), first electrode (140), second electrode (150), second substrate (130), and electro-optic medium layer (160).

Protective layer (110) is transparent and flexible. Protective layer (110) may comprise PVDC, PCTFE, polyethylene resin, polypropylene resin, acrylic resin, or polyimide, etc. Two protective layers (110) are placed sandwiching other elements. Two protective layers (110) are not an essential component of display member (100), and either or both of them may be excluded.

First substrate (120) is placed on the opposite side of first electrode (140) from electro-optic medium layer (160). First substrate (120) provides physical support to and maintain first electrode (140) in an appropriate form. First substrate (120) may protect electro-optic medium layer (160) from moisture or ultraviolet ray. First electrode (120) is flexible and transparent. Materials that can be used for first substrate (120) include PVDC, PCTFE, polyethylene resin, polypropylene resin, acrylic resin, and polyimide.

First electrode (140) is interposed between first substrate (120) and electro-optic medium layer (160). First electrode (140) is transparent and electrically conductive. Materials that can be used for first electrode (140) include indium tin oxide (ITO) and indium zinc oxide (IZO).

Second substrate (130) is placed on the opposite side of second electrode (150) from electro-optic medium layer (160). Second substrate (130) is flexible. Second substrate (130) provides physical support to and maintain second electrode (150) in an appropriate form. Second substrate (130) may protect electro-optic medium layer (160) from moisture or ultraviolet ray. Materials that can be used for second electrode (130) include PVDC, PCTFE, polyethylene resin, polypropylene resin, acrylic resin, and polyimide.

Second electrode (150) is electrically conductive, and interposed between second substrate (130) and electro-optic medium layer (160). Materials that can be used for second electrode (150) include ITO, IZO, carbon, aluminum (Al), and copper (Cu).

Electro-optic medium layer (160) is interposed between first electrode (140) and second electrode (150). Electro-optic medium layer (160) comprises a dielectric liquid (163) and electrophoretic media (161, 162) enclosed in microcapsules. Electrophoretic media comprise first electrophoretic media (161) and second electrophoretic media (162). First electrophoretic media (161) are white-colored and exhibit a positive electric charge. Second electrophoretic media (162) are black-colored and exhibit a negative electric charge. Electro-optic medium layer (160) comprises viscous binder (164) that maintains appropriate cohesion among the components.

Display member (100) may be formed by joining electro-optic display frontplane (170), backplane (180), and protective layers (110) by means of such methods as hot-roll lamination. Frontplane (170) is commercially produced by such companies as E Ink Corporation. A PET film coated with carbon, aluminum, ITO, or the like may be used as backplane (180).

An electric field is created by first electrode (140) and second electrode (150), and first electrophoretic media (161) and second electrophoretic media (162) respectively move toward opposite electrodes. For example, if first electrode (140) exhibits a negative potential relative to second electrode (150), first electrophoretic media (161) migrate toward first electrode (140) and second electrophoretic media (162) migrate toward second electrode (150), causing effective display area (100a) of display member (100) to exhibit a white color. In contrast, if first electrode (140) exhibits a positive potential relative to second electrode (150), second electrophoretic media (162) migrate toward first electrode (140) and first electrophoretic media (161) migrate toward second electrode (150), causing effective display area (100a) of display member (100) to exhibit a black color.

Between the layers of display member (100) as illustrated in FIG. 4, additional layers not shown in FIG. 4 may be provided. For example, between protective layer (110) and first substrate (120) or second substrate (130), or on the opposite side of protective layer (110), a layer of ultraviolet ray barrier or moisture barrier may be added. Also, for joining the layers illustrated in FIG. 4 together, anisotropically conductive, isotropically conductive, dielectric, transparent, opaque, and/or other adhesive agents may be used in an appropriate manner. Also, display member (100) may be such that it comprises different elements, depending for example on the producer of the frontplane, the driving method, and the type of electro-optic medium if electrophoretic medium is not used. For example, a color filter may be added; a layer of thin film transistors may be included; an electrode compatible with a matrix driving method may be included; or a layer each of titanium dioxide (TiO2) and tin oxide (SnO2) may be included if an electro-chromic medium is used. Also, a transparent or translucent film having a textured surface or having a native or printed color may be affixed on the surface of effective display area (100a).

Instead of or in addition to an electrophoretic medium, display member (100) may comprise at least a member of the group consisting of different reflective display media.

Support member (200) provides physical support to display member (100). Support member (200) comprises display panel support bars (220), vertical support rods (210), and a floor stand (230). Display panel support bars (220) comprise first elongated recess (221) and second elongated recess (222). One edge of display member (100) is inserted in first elongated recess (221) and the opposite edge is inserted in second elongated recess (222), display member (100) forming a cylindrical shape. An adhesive agent may be used in affixing display member (100) to display panel support bars (220). Display panel support bars (220) are placed in a substantially collinear manner, and connecting member (400) described below passes through the space between two display panel support bars (220). Vertical support rods (210) provide physical support to display panel support bars (220). Floor stand (230) provides physical support to vertical support rods (210). Floor stand (230) is in the shape of a disk.

Controller device (300) drives display member (100). Controller device (300) comprises a power supply member, an electric circuit, and a microprocessor device. The power supply member is supplied with an electric current from a power source and supplies an appropriate electric current to the electric circuit and the microprocessor device; the microprocessor device includes a program controlling what voltage is applied in what sequence and interval to display member (100); and the electric circuit applies a voltage to display member (100) in accordance with the program included in the micro microprocessor device. The power supply member may be electrically connected to a battery or an alternating current power source.

Controller device (300) creates an electric field between first electrode (140) and second electrode (150) by supplying voltages to the two electrodes in appropriate waveforms depending on how the optical state of display member (100) is to change. First electrode (140) is electrically connected to controller device (300), but is used as a ground electrode and thus is not supplied with a voltage. An electric field is created by the application of a positive or negative voltage to second electrode (150). However, an electrical field may be created by the application of a positive voltage to first electrode (140) or second electrode (150). In such a case, when first electrode (140) has a positive potential relative to second electrode (150), a positive voltage is applied to first electrode (140) and no voltage is applied to second electrode (150); and when second electrode (150) has a positive potential relative to first electrode (140), a positive voltage is applied to second electrode (150) and no voltage is applied to first electrode (140).

A direct drive STN LCD controller may be used to as controller device (300). Direct drive STN LCD controllers are readily available in the market, and generally capable of both of the two above-mentioned methods of creating an electric field between two electrodes. If display member (100) includes a matrix-type electrode or a TFT layer, a passive matrix or an active matrix display controller may be used.

Connecting member (400) provides electric connection between controller device (300) and display member (100). Electric signals created by controller device (300) are applied to display member (100) through connecting member (400). Referring to FIG. 5, connecting member (400) comprises first voltage rail (410), second voltage rail (420), and dielectric member (430). First voltage rail (410) and second voltage rail (420) are electrically separated by dielectric member (430). Also, first voltage rail (410) and second voltage rail (420) may be electrically separated by physically separating the voltage rails, without dielectric member (430) involved. First voltage rail (410) is connected to first electrode (140), and second voltage rail (420) is connected to second electrode (150). Connecting member (400) may be provided by combining two strips of film made of dielectric polymer coated on one side with an electric conductor such as aluminum, silver, or carbon, so that the electric conductors face away from each other; or by coating an electrical conductor on both sides of a strip of dielectric film.

Alternatively, first voltage rail (410) may comprise an extension of first electrode (140), and second voltage rail (420) may comprise an extension of second electrode (150). An extension of first electrode (140) may be provided by removing electro-optic medium layer (160) from frontplane (170), by means of such methods as those described in U.S. Pat. Nos. 6,982,178 (assigned to E Ink Corporation) and 6,873,452 (assigned to Sipix Imaging, Inc.). An extension of the second electrode may be provided by cutting backplane (180) in an appropriate shape.

Placement member (500) is a member on or by which merchandise is put in a display position. Merchandise may be placed by the force of gravity on cylindrical display member (100), and in this case the surface of effective display area (100a) of cylindrically-formed display member (100) provides placement member (500). Also, for example, an article of merchandise such as a wristwatch, a bracelet, or a ring may be placed on cylindrically-formed display member (100), cylindrically-formed display member (100) providing placement member (500).

Embodiment No. 1 may take a derivative form. For example a merchandise display device for displaying a hat, a necklace, or a clothing item on or near effective display area (100a) may be provided, by a plurality of cylindrically-formed display panels and display panel support bars (220) collectively forming the shape of a human body part comprising at least a member of the group consisting of torso, head, arm, and leg. For another example, display member (100) may be of a three-dimensional shape that is non-cylindrical, such as the human torso, providing a placement member for displaying an article of merchandise such as a necklace on the surface of effective display area (100a).

### Embodiment No. 2

FIG. 6 is an isometric view of an embodiment of the present invention referred to in this application as Embodiment No. 2.

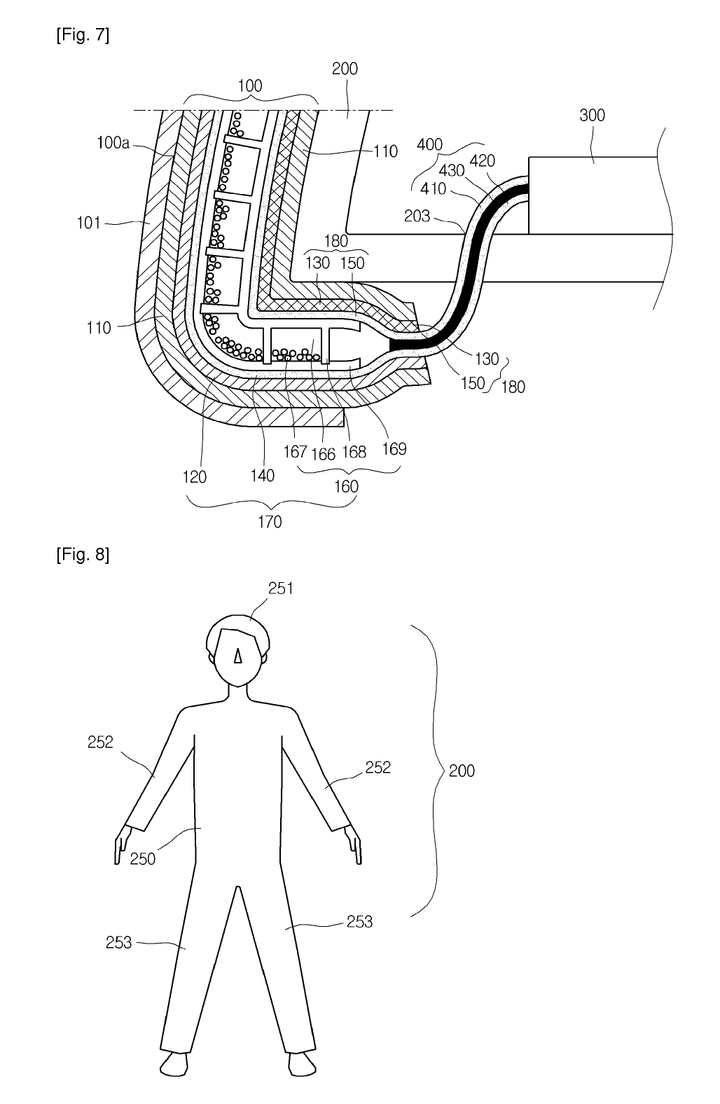

FIG. 7 is a schematic cross sectional view taken along the plane indicated by III-III in FIG. 6

In reference to FIGS. 6 and 7, a merchandise display device comprises display member (100), support member (200), controller device (300), connecting member (400), and placement member (500).

Display member (100) includes overlay layer (101), protective layers (110), first substrate (120), first electrode (140), second electrode (150), second substrate (130), electro-optic medium layer (160), and effective display area (110a). With respect to protective layers (110), first substrate (120), first electrode (140), second electrode (150), second substrate (130), and effective display area (110a), Embodiment No. 1 is referenced.

Overlay layer (101) is provided upon protective layer (110) of effective display area (100a) or, if protective layer (110) is excluded, upon first substrate (120). Overlay layer (101) is a transparent or translucent film, or a layer of cured material, and may have a certain color or colors, an image or images, or a texture or textures.

Electro-optic medium layer (160) is interposed between first electrode (140) and second electrode (150). Electro-optic medium layer (160) comprises dielectric liquid (166) and electro-optic media (167) enclosed in micro-cavities (168) sealed by sealing member (169). Dielectric liquid (166) has a certain color. Electro-optic media (167) visually contrast dielectric liquid (166), and exhibit a positive electric charge. Electro-optic media (167) may alternatively exhibit a negative electric charge.

Display member (100) is formed by joining electro-optic display frontplane (170), backplane (180), and protective layers (110) by means of such methods as hot-roll lamination. Frontplane (170) is commercially produced by such companies as Sipix Imaging, Inc. Such materials as a PET film coated with an electric conductor may be used as backplane (180). Frontplane (170) and backplane (180) may be first cut in a shape that includes below-described protrusions (241, 242) and then joined, or first joined and then cut in such a shape. For cutting frontplane (170), backplane (180), or the structure formed by joining frontplane (170) and backplane (180), a commercially available cutting plotter or laser cutter can be used.

An electric field is generated by first electrode (140) and second electrode (150), causing electro-optic media (167) to move toward one of the two electrodes. For example, when first electrode (140) has a negative potential relative to second electrode (150), electro-optic media (167) migrate toward first electrode (140), causing effective display area (100a) of display member (100) to exhibit the color of electro-optic media (167). In contrast, when first electrode (140) has a positive potential relative to second electrode (150), electro-optic media (167) migrate toward second electrode (150), causing effective display area (100a) of display member (100) to exhibit the color of dielectric liquid (166).

Display member (100) includes one continuous frontplane (170) and one continuous backplane (180). Alternatively, however, display member (100) may include a single display panel that in turn includes a plurality of frontplanes (170) disposed, on substantially the same plane, on single backplane (180) that is larger in area than any of frontplanes (170).

Between any two layers of display member (100) as illustrated in FIG. 7, additional layers not shown in FIG. 7 may be provided. For example, a layer of moisture or UV barrier may be provided between protective layer (110) and first substrate (120) or second substrate (130), or on the opposite side of protective layer (110). For another example, between the layers illustrated in FIG. 7, anisotropically conductive, isotropically conductive, dielectric, opaque, and/or transparent adhesive agents may be provided. Also, display member (100) may be structured differently from that illustrated in FIG. 7, depending on such factors as the producer of frontplane, the display driving method, and the type of electro-optic medium if electrophoretic medium is not used.

Instead of or in addition to electrophoretic media, display member (100) may include at least a member from the group consisting of other non-emissive display media.

Support member (200) is of a planar shape including upper part (201) and lower part (202), the two parts forming a predetermined angle. The angle may be about 90 degrees or about 170 degrees. Upper part (201) is curved. Upper part (201) includes first protrusion (241) extending upwardly and second protrusions (242) extending sideways. Upper part (201) may include additional protrusions, and first (241), second (242), and additional protrusions may be shaped similarly to human body parts such as head, arm, or leg. Alternatively, upper part (201) may be of a three-dimensional, rather than a planar, shape. Lower part (202) includes opening (203) through which below-described connecting member (400) runs.

Upper part (201) is of substantially the same shape as display member (100); alternatively, however, upper part (201) may be smaller than or shaped differently from display member (100) while display member (100) includes protrusions (241, 242).

Support member (200) may also be made of such materials as relatively thick metal wires or nets.

Controller device (300) is disposed on lower part (202). Embodiment No. 1 is referenced for further details of controller device (300).

Connecting member (400) provides electrical connection between controller device (300) and display member (100). Connecting member (400) passes through opening (203) of lower part (202) of support member (100). If a plurality of frontplanes (170) and a single backplane (180) are included in display member (100), second voltage rail (420) is in electrical contact with first electrodes (140) of all frontplanes (170). Embodiment No. 1 is referenced for further details of connecting member (400).

Placement member (500) provides means for placing merchandise on effective display area (100a) by the force of gravity. Such merchandise as a necklace is placed between first protrusion (241) and second protrusion (242). In other words, placement member (500) is provided by first and second protrusions (241, 242), and by the structure formed by the joining of display member (100) and support member (200). If upper part (202) of the support member is of a three-dimensional shape or includes additional protrusions; or if first (241), second (242) and/or additional protrusions are shaped similarly to human body parts such as head, arm, or leg; then the three-dimensional shape, first protrusion (241), second protrusion (242) and/or additional protrusions may provide placement member (500) on which such merchandise as a garment, a cap, or a necklace may be placed.

### Embodiment No. 3

FIG. 8 is a schematic front view of the support member of an embodiment of the present invention referred to in this application as Embodiment No. 3. With regard to Embodiment No. 3, the support member and the placement member are described in detail, and Embodiment No. 2 is referenced for details of the display member, the controller device and the connecting member.

In reference to FIG. 8, support member (200) is of a shape a human mannequin. Support member (200) includes body (250), head (251), arms (252), and legs (253). Support member (200) may be of a three-dimensional shape having a predetermined volume. Body (250) may be of a partially cylindrical shape, of which the radius may vary along the height. Head (251) extends upwardly from body (250), and is thinner than body (250). Arms (252) extend sideways from body (250), and are thinner than head (251). Legs (253) extend downwardly from body (250), and are thinner than body (250).

Support member (200) may be made of such materials as wood, an opaque polymer resin, a transparent polymer resin, or relatively thick metal wires or nets. Support member (200) may be a part of or comprise at least a portion of a voltage rail that electrically connects controller device (300) and display member (100). Support member (200) may be made of an electrically conductive material and provide the electrical connection between display member (100) and controller device (300). Also, support member (200) may include an opening or openings through which a voltage rail passes. Display member (100) is placed on support member (200). If support member (200) is of a three-dimensional shape, display member (100) may include a plurality of display panels.

The upper and/or side surfaces of body (250), head (251), arms (252) and/or leg (253) provide placement member (500). By gravity and/or other forces, placement member (500) maintains an article of merchandise in a display position. For example a cap may be placed upon the upper surface of head (251); a necklace may be placed upon the upper surface of body (250); shirts may be placed upon the upper and side surfaces of body (250) and arms (252); and swimwear may be placed upon side surfaces of legs (253).

### Embodiment No. 4

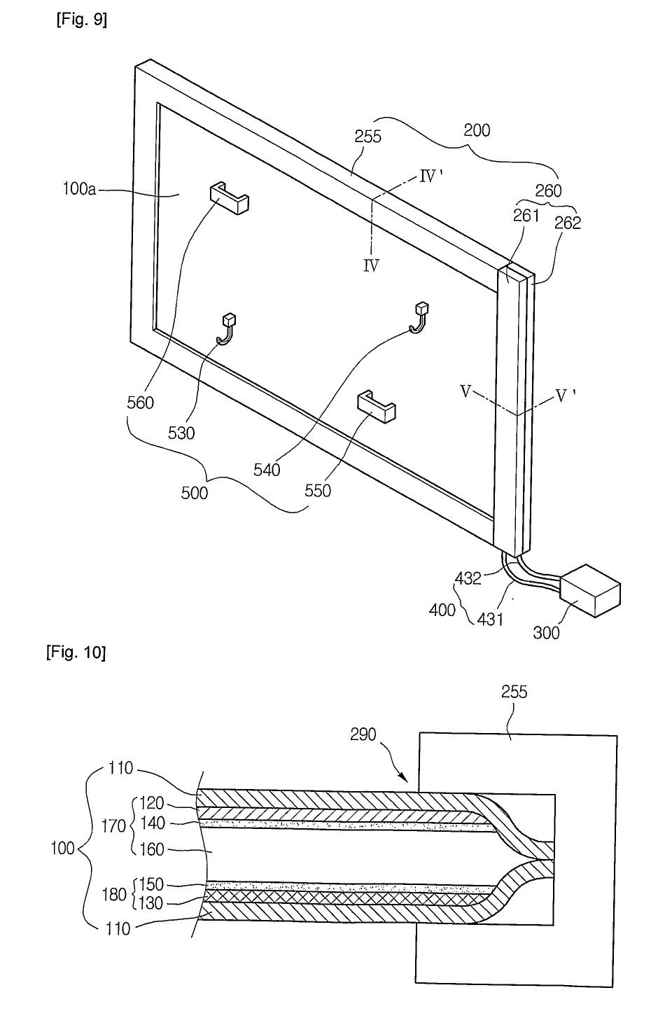

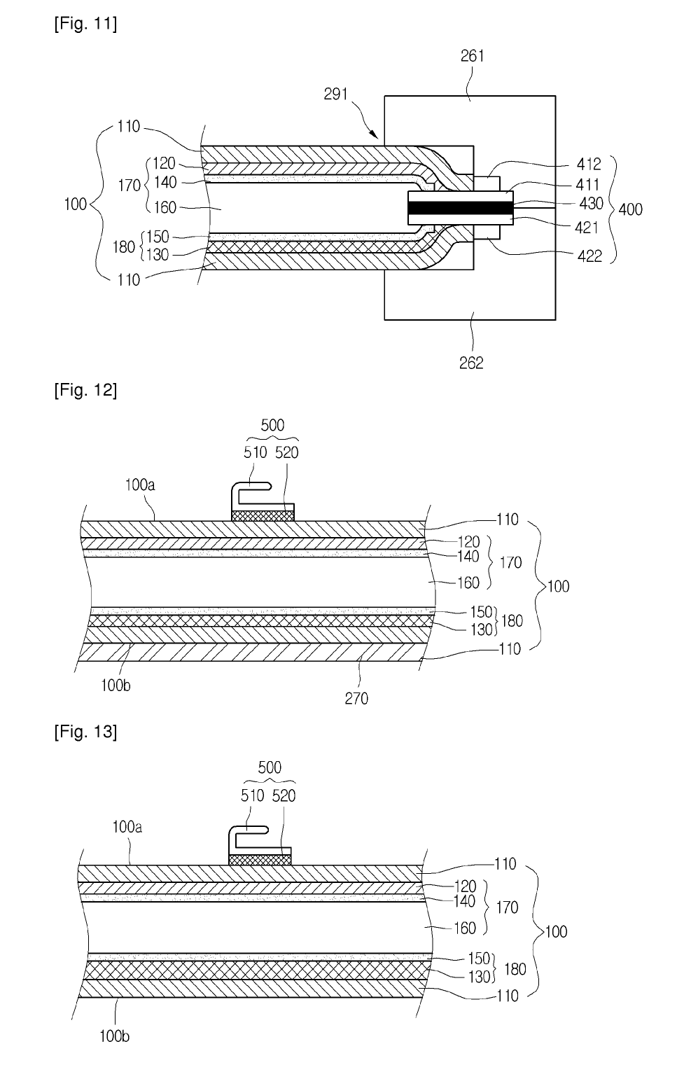

FIG. 9 is an isometric view of an embodiment of the present invention referred to in this application as Embodiment No. 4. FIG. 10 is a schematic cross sectional view taken along the plane indicated by IV-IV′ in FIG. 9. FIG. 11 is a schematic cross sectional view taken along the plane indicated by V-V′ in FIG. 9.

In reference to FIGS. 9, 10, and 11, a merchandise display device includes display member (100), support member (200), placement member (500), controller device (300), and connecting member (400).

Display member (100) is of a planar shape. Only one side of display member (100) may be effective display area (100a), or both sides of display member (100) may be effective display areas (100a). If both sides of display member (100) are effective display areas (100a), second electrode (150) is made of a transparent electrical conductor such as ITO, and second substrate (130) is made of a transparent substrate as PET or glass. A PET film coated with a transparent conductor such as ITO may be used as backplane (180) if both sides of display member (100) are effective display areas (100a). On one side or both sides of display member (100), a planar member of substantially the same shape as display member (100) may be provided, in order to provide physical support to display member (100). For further details of display member (100), Embodiment No. 1 or Embodiment No. 2 is referenced.

In reference to FIG. 9, support member (200) is of a shape similar to a picture frame. Support member (200) comprises first support element (255) shaped like a picture frame with one edge open, and second support element (260) shaped like a beam including groove (291).

In reference to FIG. 10, first support element (255) includes groove (290). Groove (290) is on the inner sides of first support element (255), and display member (100) is inserted in groove (290). The elastic force of first support element (255) generated by inserting display member (100) in groove (290), or an adhesive agent such as a pressure-sensitive adhesive, may be used to maintain display member (100) in place. Alternatively or additionally, an elastic member may be provided between groove (290) and display member (100) to join display member (100) and first support element (255).

In reference to FIG. 11, second support element (260) comprises upper piece (261) and lower piece (262). Second support element (260) comprises third voltage rail (412) electrically connected to first voltage rail (411) which is in turn electrically connected to first electrode (140); and fourth voltage rail (422) electrically connected to second voltage rail (421) which is in turn electrically connected to second electrode (150). Upper piece (261) comprises third voltage rail (412). Lower piece (262) comprises fourth voltage rail (422). First voltage rail (411) and second voltage rail (421) are electrically separated by insulator (430). First voltage rail (411), second voltage rail (421) and insulator (430) may be provided by joining two strips of dielectric films coated with an electric conductor such as aluminum, silver, ITO, copper, or carbon, so that the electric conductors face outward; or by coating both sides of a dielectric film with an electric conductor. Electric conductors such as aluminum, silver, ITO, copper, and carbon may be used for third and fourth voltage rails (412, 422). Third and fourth voltage rails (412, 422) are provided along the length of upper piece (261) and lower piece (262) respectively, and are electrically connected to below-described fifth voltage rail (431) and sixth voltage rail (432) respectively. First (411), second (421), third (412), and forth (422) voltage rails, as well as insulator (430) are included in below-described connecting member (400).

Upper piece (261) and lower piece (262) of second support element (260) may be joined by such means as adhesives, screws, or bolts and nuts. Second support element (260) has groove (291). Second support element (260) and display member (100) may be joined by such means as the elastic force of second support element (260) caused by groove (291), a pressure-sensitive adhesive, or an additional elastic member.

Support member (200) may be of a shape of a grid rather than a picture frame, wherein a plurality of grooves are provided on support member (200) and a plurality of display members (100) are inserted in the grooves. Also, support member (200) may be of a shape based on a non-rectangular form, rather than the shape of a picture frame or a grid.

For detailed descriptions of controller device (300), Embodiment No. 1 and Embodiment No. 2 are referenced.

Connecting member (400) electrically connects controller device (300) and display member (100). Connecting member (400) includes fifth voltage rail (431) and sixth voltage rail (432), in addition to first (411), second (421), third (412), and fourth (422) voltage rails. One end of fifth voltage rail (431) is connected to third voltage rail (412) by such means as an electrically conductive adhesive or a hardware connector. The other end of fifth voltage rail (431) is connected to controller device (300). One end of sixth voltage rail (432) is connected to fourth voltage rail (422) by such means as an electrically conductive adhesive or a hardware connector. The other end of sixth voltage rail (432) is connected to controller device (300). Electric signals generated by controller device (300) are applied to display member (100) through connecting member (400).

Placement member (500) is provided on the surface of display member (100). Placement member may include such means for placing merchandise in a display position as hooks (530, 540) or hollow bricks with two sides open (550, 560). One surface of such means (530, 540, 550, 560) is affixed to display member (100) by an adhesive. Placement member (500) places and maintains merchandise in a display position. By the pull of gravity, at least a portion of merchandise is placed still on placement member (500), and the merchandise is displayed on or near effective display area (100a).

A merchandise display device according to Embodiment No. 4 may be hung on a wall or placed on a stand.

### Embodiment No. 5

FIG. 12 is a schematic cross sectional view of the placement member and the display member of an embodiment of the present invention referred to in this application as Embodiment No. 5. For detailed descriptions of the display member, the connecting member, and the controller device, Embodiment No. 4 is referenced. Descriptions of the support member and the placement member are provided below.

As in the case of and in reference to Embodiment No. 4, support member (200) comprises first support element (250) and second support element (260), but further comprises planar third support element (270) made of a ferromagnetic or paramagnetic material. Third support element (270) is affixed to non-effective display area (100b) of display member (100). A pressure-sensitive or a hot-melt adhesive may be used for joining third support element (270) and display member (100).

A ferromagnetic or a paramagnetic material becomes magnetized if put in a magnetic field, and for the purpose of this application, is defined as a material attracted to a magnet. A ferromagnetic material remains magnetized at least for some time even if the magnetic field is removed; a paramagnetic material loses its magnetic characteristics if the magnetic field is removed. For Embodiment No. 5, a ferromagnetic material is preferred to a paramagnetic material, as the former responds to a magnetic field more strongly than the latter. Materials suitable for third support element (270) include steel, a steel composite, nickel, a nickel composite, and the like.

Placement member (500) is provided on effective display area (100a) of display member (100). Placement member (500) comprises merchandise placement element (510) and fixing element (520). Merchandise placement element (510) puts an article of merchandise in a display position by the gravitational force. Merchandise placement element (510) is hook-shaped, and is affixed to fixing element (520) by such means as an adhesive. Alternatively, merchandise placement element (510) and fixing element (520) may be in a physically continuous unit. Fixing element (520) comprises a magnet. Fixing element (520) is affixed on effective display area (100a) by the magnetic force between fixing element (520) and third support element (270). Alternatively, a ferromagnetic or a paramagnetic material may be used for fixing element (520) and a magnet may be included third support element (270). In order to prevent a physical damage to display member (100), a layer of soft material such as soft fabric may be glued on fixing element (520).

### Embodiment No. 6

FIG. 13 is a schematic cross sectional view of the placement member and the display member of an embodiment of the present invention referred to in this application as Embodiment No. 6. For details of the support member, the connecting member, and the controller device, Embodiment No. 4 is referenced; and for details of the placement member, Embodiment No. 5 is referenced. A detailed description of the display member is provided below.

In reference to FIG. 13, display member (100) comprises protective layers (110), first substrate (120), first electrode (140), second electrode (150), second substrate (130), and electro-optic medium layer (160). For detailed descriptions of protective layers (110), first substrate (120), first electrode (140), second substrate (130), and electro-optic medium layer (160), Embodiment No. 1 and Embodiment No. 2 are referenced. A detailed description of second electrode (150) is provided below.

Second electrode (150) is interposed between second substrate (130) and electro-optic medium layer (160). Second electrode (150) exhibits ferromagnetic characteristics and an electric conductivity. Materials suitable for second electrode (150) include nickel and nickel composites. Such materials as a PET film coated with nickel or a nickel composite may be used as backplane (180), thereby providing second electrode (150). Nickel-coated PET films are commercially available.

The present invention is described in detail above in reference to certain embodiments. However, there may be various additional embodiments of the present invention, for example: a plurality of picture-frame-shaped merchandise display devices according to Embodiment No. 4 connected laterally by hinges; or an embodiment wherein electrodes, voltage rails, and controller device are configured so that the display member is capable of showing changing texts and/or patterns in addition to changing colors.

1. A merchandise display device comprising:
a non-emissive electro-optic display member having an effective display area that does not emit light, said electro-optic display member comprising at least one electrode;
a first means for displaying merchandise on or near said effective display area;
a second means for providing physical support to said electro-optic display member;
a controller device for driving said electro-optic display member; and
a third means for electrically connecting said electro-optic display member and said controller device,
whereby said effective display area is used as background of displaying said merchandise.

2. The device of claim 1, wherein said electro-optic display member comprises a plurality of display panels capable of displaying colors or images.

3. The device of claim 1, wherein said electro-optic display member comprises:
a separately-fabricated frontplane comprising a first electrode and an electro-optic medium layer the optical state of which changes in accordance with an electric signal generated by said controller device; and
a separately-fabricated backplane comprising a second electrode abutting against said frontplane.

4. The device of claim 3, wherein at least one of said first electrode and said second electrode is supplied with said electric signal.

5. The device of claim 3, wherein a plurality of said frontplanes smaller than said backplane are disposed on the same plane on said backplane.

6. The device of claim 1, wherein said electro-optic display member comprises a bistable electro-optic medium.

7. The device of claim 1, wherein said second means comprises:
an upper part;
a lower part extending from said upper part in a predetermined angle between 90 and 170 degrees; and
a protrusion extending from said upper part.

8. The device of claim 1, wherein said electro-optic display member comprises:
a flexible substrate; and
a surface area being planar and not substantially flat.

9. The device of claim 1, further comprising an overlay layer having a predetermined color or predetermined colors or being transparent or translucent.

10. The device of claim 1, wherein said electro-optic display member comprises:
a first electrode;
a second electrode; and
a medium of a predetermined color, exhibiting a positive or a negative electric charge, interposed between said first electrode and said second electrode.

11. The device of claim 10, wherein said medium comprises:
a first medium of a predetermined first color, exhibiting a positive electric charge; and
a second medium of a predetermined second color, exhibiting a negative electric charge.

12. The device of claim 1, wherein said first means for displaying merchandise on or near said effective display area comprises said electro-optic display member.

13. The device of claim 1, wherein said first means for displaying merchandise on or near said effective display area is affixed by means of a magnetic force onto said electro-optic display member or onto said second means for providing physical support to said electro-optic display member.

14. The device of claim 1, wherein said second means for providing physical support to said electro-optic display member comprises a groove in which said electro-optic display member is inserted.

15. The device of claim 1, wherein said electro-optic display member and said controller device are electrically connected by said second means for providing physical support to said electro-optic display member.

16. The device of claim 1, wherein said electro-optic display member or said second means for providing physical support to said electro-optic display member comprises a body portion, and further comprises at least one member of the group consisting of a head portion extending upwardly from said body portion, an arm portion extending sideways from said body portion, and a leg portion extending downwardly from said body portion.

17. A method of fabricating a merchandise display device comprising:
providing a frontplane comprising a first electrode and an electro-optic medium layer;
providing a backplane comprising a second electrode;
providing a non-emissive electro-optic display member having an effective display area capable of displaying colors or images, by joining said frontplane and said backplane;
providing a first means for displaying merchandise on or near said effective display area;
providing a second means for providing physical support to said electro-optic display member;
providing a controller device supplying an electric signal to said electro-optic display member;
providing a third means for electrically connecting said electro-optic display member and said controller device,
whereby said effective display area is used as background of displaying said merchandise.
